(19) United States
(12) Patent Application Publication
(10) Pub. No.: US 2017/0051191 A1
(43) Pub. Date: Feb. 23, 2017

(54) DRYING, SIZING AND SHAPING PROCESS TO MANUFACTURE CERAMIC ABRASIVE GRAIN

(71) Applicant: Shengguo WANG, Shanghai (CN)

(72) Inventor: Shengguo WANG, Shanghai (CN)

(21) Appl. No.: 15/308,261

(22) PCT Filed: May 2, 2014
(86) PCT No.: PCT/CN2014/076698

§ 371 Date: Nov. 1, 2016

(51) Int. Cl. C09K 3/14; B24D 11/00; C04B 35/622; C04B 35/626; C04B 35/10; C04B 35/624

(52) U.S. Cl. CPC C09K 3/1409; C04B 35/10; C04B 35/624; C04B 35/62218; C04B 35/626; B24D 11/001; C04B 2235/3205; C04B 2235/6023; C04B 2235/612

(57) ABSTRACT

A sol gel abrasive gain and the preparing method thereof are provided. The abrasive grains deriving from alumina powders have various shapes and sizes and can be used to make a bonded or coated abrasive product. The preparing method comprises: coating alumina monohydrate sol to a carrier backing by roller coating, knife coating or extrusion coating method, etc., drying the coating to a high-solid state in a continuous dryer such as backing treatment oven, festoon oven or drum dryer, then shaping and sizing by patterned rollers or screen web, etc., further drying the shaped gel and then calcining, impregnating and sintering the gel to obtain microcrystalline ceramic grains.

### FIELD OF TECHNOLOGY

The invention relates to a new method and equipment to manufacture sol gel abrasive grain with greatly improved productivity and usable grit size while maintaining or improving its grinding performance.

### DESCRIPTION OF RELATED ARTS

A major focus in the abrasive industry today is the development of more efficient abrasive grain having high cut rate and longer service life for both light and high pressure grinding applications.

As known to us, the present alumina abrasive grains include fused abrasive grain such as brown fused alumina, white fused alumina, mono crystal alumina and semi-friable alumina and sintered abrasive grain such as sol gel abrasive. Fused alumina abrasive is melted in tilting furnace and poured into ingots of sizes suitable for the desired rate of cooling and resulting crystal size. Because of its low cost due to mass production and cheap raw material, fused alumina abrasive grain is widely used in coated and bonded abrasive products, but its grinding performance including cut rate and total cut or grinding ratio is limited.

Since the early 1980's, sol-gel technology has been used to improve the performance of alumina abrasive and has had a major impact on both the coated and bonded abrasive business. Sol-gel processing permits the microstructure of the alumina to be controlled to a much greater extent than is possible by the fusion process. Consequently, the sol-gel abrasive has a crystal size several orders of magnitude smaller than that of the fused abrasive and exhibit a corresponding increase in toughness and abrasive performance.

During the last several decades, many efforts are put on how to increase the grinding performance of sol-gel abrasive grain. These efforts include exploring additives such as modifiers and sintering aids, seeds and optimizing manufacturing process such as shaping and sintering techniques. These activities are described in patents such as U.S. Pat. No. 4,314,827, U.S. Pat. No. 4,518,397, U.S. Pat. No. 4,623,364, U.S. Pat. Nos. 4,770,671, 4,799,938, 4,848,041, U.S. Pat. No. 4,881,951, U.S. Pat. No. 4,964,883, U.S. Pat. No. 5,034,360, U.S. Pat. No. 5,090,968, U.S. Pat. No. 5,106,791, U.S. Pat. No. 5,190,567, U.S. Pat. No. 5,194,073, U.S. Pat. No. 5,227,104, U.S. Pat. No. 5,244,477, U.S. Pat. No. 5,431,704, U.S. Pat. No. 5,453,104, U.S. Pat. No. 5,489,204, U.S. Pat. No. 5,531,799, U.S. Pat. No. 5,660,604, U.S. Pat. No. 5,984,988, U.S. Pat. No. 6,258,141, U.S. Pat. No. 6,802,878, etc. Since 2009, 3M introduced Cubitron II sol gel abrasive grain, which revolutionarily improved the grinding performance by shaping technology.

The traditional manufacturing process of sol gel abrasive grain (as described in the cited patents) includes the following steps:

(1) Dispersion preparation: usually it takes 30˜60 minutes (2) Gelling the dispersion: 10˜30 minutes, (3) Drying or Crushing or shaping: for traditional drying/crushing process, the sol or gel is dried in a pan for 24˜48 hours @ 70˜100 centigrade, for extruded filament drying process, the sol or gel is dried 24˜72 hours at 75˜80 centigrade as described in U.S. Pat. No. 5,372,620 (4) Calcining: 10˜60 minutes. (5) Sintering: from 5˜120 minutes. Other optional process includes vacuum, centrifuge and impregnation, etc.

We can easily see that the sol gel manufacturing process is batch production and the bottle neck of the process is drying process. The drying step took more than 80˜90% of the production time, if we can reduce the drying time, the sol gel abrasive is ready for mass production and the manufacturing cost can be greatly reduced.

In the conventional manufacturing process of sol gel abrasive grain, the drying step is very critical. The lower a drying temperature is, the higher density of sintered grains. For pan drying process, because the thickness of the sol or gel is several centimeters, the drying temperature and time is carefully controlled to avoid bubble or froth formation, which will impair the sintered density and grinding performance. So the pan drying temperature is low, usually 70˜90 centigrade and the drying time is long, 24˜48 hours. Therefore the manufacturing productivity is very low. The pan drying process usually needs crushing step. Some fine gits (finer than P120 or F120) are produced during the crushing step, and as known to the industry, the fine grits of sol-gel abrasive has no obvious advantage over fused abrasive when the grit size is smaller than P120 or F120. So these fine grits has to be recycled or disposed, which would increase the manufacturing cost.

US 2009/0165394 A1 described a screen printing process to shaping and drying the gel. The drying time is reduced to several minutes, but the drying oven is so short, as described in that patent, only 27 foot, including 2 zones, not festoon oven or multiple pass conveyer dryer with high productivity, so the coating/drying speed is very slow and the coating thickness is also very thin, less than 1 millimeters, so the throughput is limited, not suitable for mass production.

Few efforts were put on how to reduce the cost of sol gel abrasive and to improve the manufacturing process of sol gel abrasive to make it suitable for mass production in the last 30 years. So the cost of sol gel abrasive is very high and it is much more expensive than fused alumina abrasive, for example, the selling price of fused brown or white alumina abrasive is about 1 US$/kg, but the selling price of sol gel abrasive grain is about 20˜30 US$/kg in China market, which limited its application to certain areas where its cost/benefit was justified. The typical application of sol gel abrasive includes stainless steel, high nickel alloys and heat sensitive metals. Since the introduction of sol gel abrasive in 1981, the total annual production volume of sol gel abrasive grain is less than 10,000 tons in the world, while the conventional fused alumina abrasive grain's annual production is more than 1,000,000 tons worldwide.

So, there is a need to reduce the raw material cost of sol gel abrasive grains and to improve the productivity and yield of usable abrasive grit sizes during the ceramic grain manufacturing process while maintaining or improving its grinding performance so that we can make it more competitive than conventional fused alumina abrasive. In this invention, we will focus on how to improve the manufacturing productivity and yield of usable grit size while maintaining or improving its grinding performance. The raw material cost down will be covered by another invention.

### SUMMARY OF THE INVENTION

It is an object of the invention to provide a drying and shaping method and/or equipment to improve the productivity and yield of usable abrasive grit sizes during the sol gel abrasive grain manufacturing process. The bottleneck of sol gel abrasive grain manufacturing process is the drying step, while the shaping of sol gel abrasive grain can tailor the grinding performance according to grinding pressure, grinding speed and metal type, etc.

In this invention, the drying, shaping and sizing process of sol gel abrasive manufacturing are improved. The invented manufacturing process of sol gel abrasive grain described as follows:

Alumina monohydrate sol or gel was coated (by knife, roller or extrusion) to a carrier backing such as PTFE or PP, PET or other heat resistant plastic film backing or even paper backing with release coating (these backing are commonly used in coated abrasive industry) and dried on a continuous dryer such as festoon oven widely used in coated abrasive industry to high-solid gel state and then sized or shaped using patterned rollers commonly used in coated abrasive industry. In the festoon oven, the gel was dried to a non-sticky state but not so dry to lose adhesion and fall off from the carrier backing. Then the partially dried gel was further dried on a convection oven including but not limited to backing treatment oven or multiple pass conveyor dryer. The drying time was greatly reduced to make sol gel abrasive grain mass production become possible and the yield of usable abrasive grit was increased due to the sizing or shaping in the gel state. Also the grinding performance of abrasive grain could be tailored to different grinding applications such as grinding pressure, speed and metal type, etc by controlling the length, width and thickness of the sole gel abrasive grain by patterned rollers or screen web.

### BRIEF DESCRIPTION OF THE DRAWINGS

FIG. 1 is manufacturing process to make sol gel abrasive grain.

FIG. 2 is manufacturing process 2 to make sol gel abrasive grain.

FIG. 3 is a patterned roller to shape and size sol gel abrasive grain.

FIG. 4 is a patterned roller to shape and size sol gel abrasive grain.

FIG. 5 is a patterned roller to shape and size sol gel abrasive grain.

FIG. 6 is patterned rollers to shape and size sol gel abrasive grain.

FIG. 7 is patterned rollers to shape and size sol gel abrasive grain.

FIG. 8 is a PTFE lined glass fiber web for shaping and sizing.

### DETAILED DESCRIPTION OF THE PREFERRED EMBODIMENT

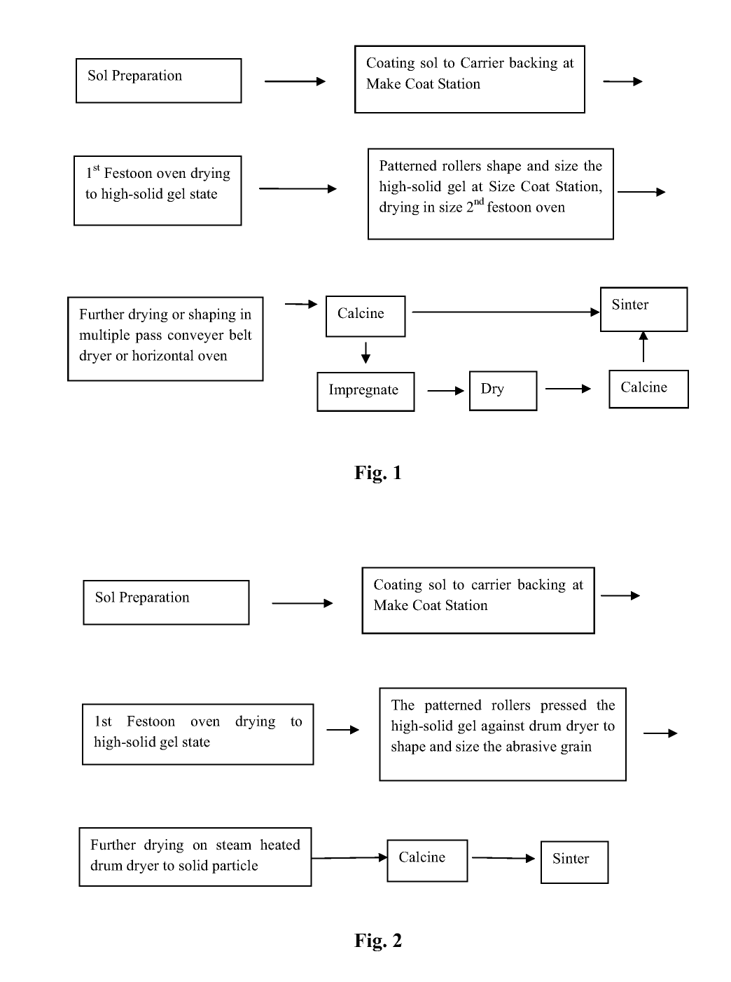

The whole sol gel abrasive manufacturing process is shown in FIGS. 1 and 2. Detailed process steps are described as follows:

(1) Sol preparation: Sol dispersion is prepared by mixing deionized water, highly dispersed alumina monohydrate, nitric acid, submicron-sized alumina seeds and other additives such as rare earth oxides to modify sintering or microstructure. The mixing equipment can be high shear mixer or ball mill or sand mill. The solid content of the dispersion is preferably from 25%˜30%.

(2) Coating sol to carrier backing at Make Coat Station: the sol prepared in step (1) is coated on a carrier backing such as plastic film including but not limited to PTFE, PET or PP or paper backing with release liner by a knife, extrusion or roll coater, depending on the sol viscosity. The coating width is usually 1.4˜1.6 meters, very common in coated abrasive industry. The coating thickness is varied according to sol viscosity, grit sizes, productivity/yield, drying temperature and drying time, and grinding performance. The coating thickness range is typically from 0.2˜5 mm. for example, for P36 grit, the preferred coating thickness is from 0.4˜0.8 mm for grinding performance. Usually thin coating thickness is better for low pressure grinding applications such as fiber disc, flap disc and woodworking products, while thick coating is better for high grinding pressure applications and high productivity/yield.

(3) 1st Festoon oven drying to high-solid gel state: The drying time and temperature are varied for different sol coating thickness and products. For 1st Festoon oven in coated abrasive production line, usually there are 2˜3 heating zones, the temperature can be set from 70 to 120 centigrade and the drying time can be 30˜120 minutes. The criterion for changing temperature and drying time is to avoid bubble or froth formation during the drying process. Usually low temperature and long drying time leads to higher sintered grain density and grinding performance. In the 1st Festoon oven the sol is dried to high-solid gel state, a little sticky and can be shaped by patterned rollers, screen webs and extruders. After 1st Festoon oven drying, the solid content is preferred to be 40˜65%, depending on the further processing requirements.

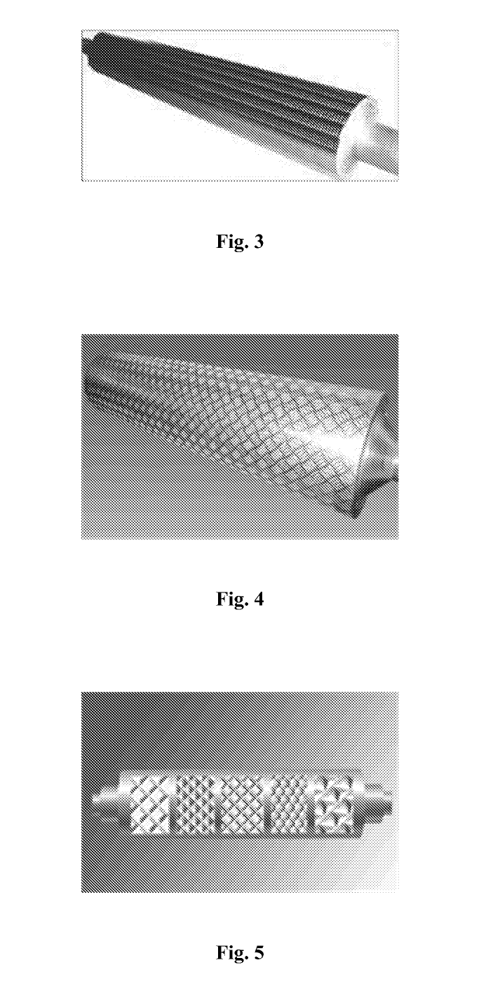

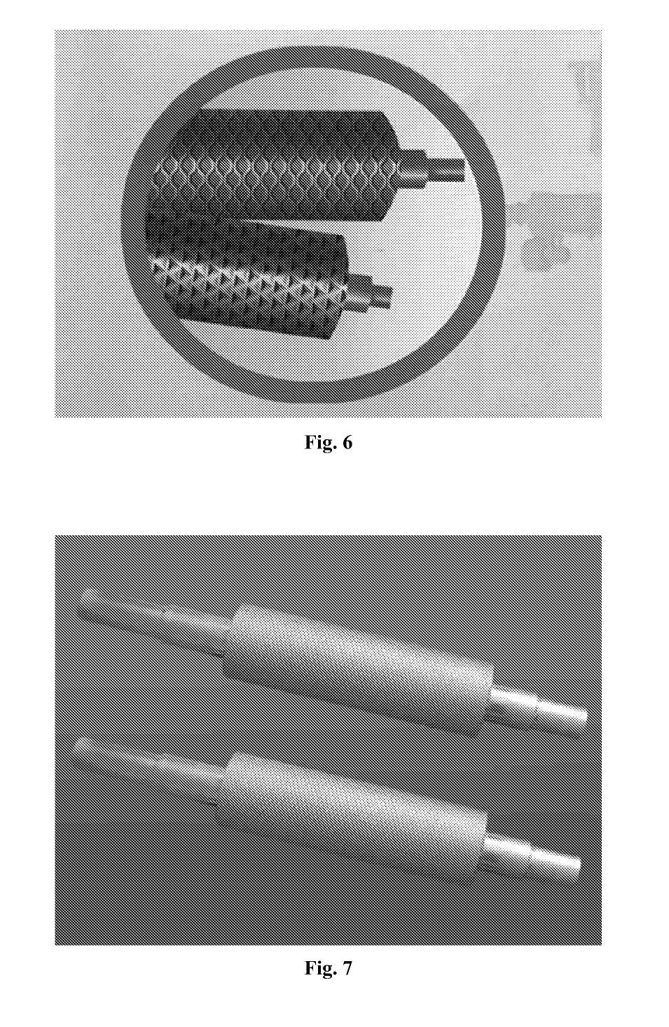

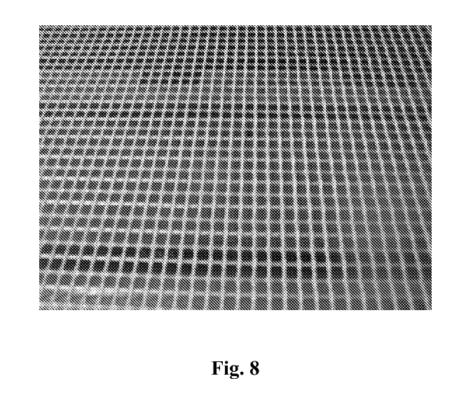

(4) Patterned rollers shaping and sizing the sol gel abrasive grain: after drying in the 1st festoon oven, the high solid gel goes to the size coater station. Patterned rollers is pressed against the gel, shaping and sizing the abrasive grit, just like the structure abrasive manufacturing process. Some patterned rollers supplied in China market is shown from FIG. 3 to FIG. 7. All the figures are just examples, not specified, any pattern rollers used in coated abrasive and other industries can be used in this invention. The shaping and sizing can also be made by pressing the PTFE lined glass fiber web described in FIG. 8 into the gel coating. The size of the rectangle is not specified, the ratio of length to width L/D can be from 1 to 2 or 3, depending on the applications, thickness is varied according to grinding applications and productivity. Other shaping and sizing technique is also suitable for the manufacturing process such as die cutting. After shaping and sizing, the gel goes into the 2nd size festoon oven for further drying. The drying is controlled to a little sticky but not so dry and lose adhesion then fall from the carrier backing. At the winding station, the dried shaped gel on carrier backing is connected to the further drying station.

(5) Further drying or shaping in multiple pass conveyer belt dryer or other horizontal convection oven: the web dried in festoon goes into the convection oven like backing treatment oven in coated abrasive industry or multiple pass conveyer belt dryer or drum dryer to make the gel dry to solid particles. The drying temperature can be from 70 to 130 centigrade and the drying time is from 2 to 20 minutes. After drying, the dried shaped particles can be wiped off from the carrier backing for the next processing steps such as calcining, impregnation and sintering.

The whole drying and shaping process can also be made on a drum dryer or multiple pass conveyor belts dryer. Drum dryers need less space and have similar productivity, but if steam pressure is high, there is risk to cause bubble or froth formation in the sol. The temperature of drum drying should be controlled not to cause frothing of the sol or gel. The patterned rollers or screen webs are also used in the process for shaping and sizing.

(6) Calcining: The dried gel is then further calcined in a rotatory furnace to remove the residue water and some volatiles. The preferred calcining temperature is from 500˜850° C. and the preferred calcining time is from 10˜60 minutes.

(7) Sintering: The calcined particle is then fed into a SiC rotatory furnace for sintering to densify the particles. The preferred sintering temperature is from 1300˜1500° C. and the preferred sintering time is from 5˜120 minutes.

1. A manufacturing process of the a sol gel abrasive grain comprising, coating a boehmite sol or gel to a carrier backing, drying the sol or gel on a continuous dryer to gel state and then shaping or sizing the gel state, and further drying the gel state on a horizontal convection oven or multiple pass conveyor belt dryer.

2. The manufacturing process according to claim 1, characterized in that the said carrier backing is a plastic film or silicone film or paper backing with release liner.

3. The manufacturing process according to claim 1, characterized in that the drying, the shaping or the sizing are all conducted on drum dryer.

4. The manufacturing process according to claim 1, characterized in that the drying, the shaping or the sizing are all conducted on multiple pass conveyer belts dryer.

5. The manufacturing process according to claim 1, characterized in that the drying is conducted in an festoon oven or horizontal convection oven or drum dryer or multiple pass conveyor dryer or other continuous dryers and the sol or gel is coated to a carrier backing and shaped by patterned rollers or screen webs.

6. The manufacturing process according to claim 1, characterized in that the drying, the shaping or the sizing are conducted on combinations of festoon oven, drum dryer, multiple pass conveyer belt dryer, coating and extrusion apparatus and shaping and sizing equipment.

7. The manufacturing process according to claim 1, characterized in that the shaping and sizing both occur and are conducted by patterned rollers, screen webs, or a combination thereof.

8. A sol gel abrasive grain with various shapes and sizes, characterized in that the drying and shaping process is described in claim 1.

9. A sintered abrasive grain derived from alumina powders, characterized in that, its abrasive grain is made by the drying, shaping and sizing process according to claim 1.

10. A bonded abrasive product, characterized in that, its abrasive grain is made by the process according to claim 1.

11. A coated abrasive product, characterized in that, its abrasive grain is made by the process according to claim 1.

12. The manufacturing process according to claim 1, wherein the continuous dryer is a festoon oven.

13. The manufacturing process according to claim 1, characterized in that the continuous dryer is one or a backing treatment oven, a drum dryer, or a multiple pass conveyor dryer.

14. The manufacturing process according to claim 1, characterized in that the gel state is both shaped and sized.

15. The manufacturing process according to claim 1, characterized in that the gel state is then shaped or sized using patterned rollers.

16. The manufacturing process according to claim 1, characterized in that the plastic film is one of polytetrafluoroethylene (PTFE), polyethylene terephthalate (PET) or polypropylene (PP).
